(19) United States
(12) Patent Application Publication
(10) Pub. No.: US 2007/0255599 A1
(43) Pub. Date: Nov. 1, 2007

(54) MyCareConnect

(76) Inventor: Mary Pamela Henry, Allen, TX (US)

Correspondence Address: Mary Henry, 1303 Mills Court, Allen, TX, 75013, US

(21) Appl. No.: 11/691,608

(22) Filed: Mar. 27, 2007

Related U.S. Application Data
(60) Provisional application No. 60/743,810, filed on Mar. 27, 2006.

(51) Int. Cl. G06F 19/00

(52) U.S. Cl. 705/3

(57) ABSTRACT

MyCareConnect (MCC) is a system and method used for the collection, management, transmission, analysis and correspondence of health related information between an individual, business, or other entity. The system and method includes the exchange of confidential health related data over a public network. The system and method includes the ability to limit access to such information by unauthorized individuals. The system and method includes a computational procedure used to create and send an electronic message transmitted over the public network, real time, as data is entered into the system. The electronic message is received through a variety of methods, Including but not exclusive to: internet, email, mobile devices (cell phone, pager, PDA), third party manufacturer devices, and locally installed applications. For example, in the case of a diabetic, a measuring device (i.e. blood glucose meter) measures a patient's physiological attribute (sugar saturation in the blood), which is then either manually entered or downloaded from the device into the MCC system. This data can then be accessed by any individual also using the system with access to this specific patient's account. This health-related data is stored in a database and interpreted in a manner that provides caregivers with accurate information to better analyze a patient's past and current status. In the instance of a caregiver, that caregiver can then use the system to correspond with the patient immediately, communicating feedback about their current state. This correspondence information is also collected in the database and can be accessed by anyone with access to this patient's account. Once correspondence is complete and considered final as it relates to the current state of the patient, the information is stored for recall at any time.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Current State:

Type 1 Diabetes is a complicated condition that requires a constant care regimen. Type 1 diabetics may test their blood sugar level four to ten times a day, monitor their carbohydrate intake and take insulin on a proportional basis. Daily recordings of these numbers, as well as carbohydrate intake, and insulin dosages are necessary for clinicians to track their patient's condition and provide proper treatment

Due to the serious nature of type 1 diabetes and the constant monitoring necessary to keep the disease under control, the ability to connect care providers to both children with type 1 diabetes and their families is critical.

Clear, frequent communication between the patient, their families and clinicians is a constant challenge. Patients typically record data by hand, inviting error and requiring additional effort; clinicians are constantly processing the enormous amount of data coming to them from patients. Phone calls and faxes are currently the main channels for communication. Both are subject to failures in communication, as messages are lost or unclear and faxes can be illegible. In many cases, multiple attempts are made between the patient and their clinician adding to the challenge.

Future State:

Two disciplines can have a dramatic impact on disease and condition management

1) Self Care

2) Applying Scientific Knowledge to Practical Problems

Studies indicate those who are taught the importance of managing their diabetes an early age, continue good habits and have better control of their diabetes as they grow older, greatly increasing their chance of avoiding the many complications that can come with this condition.

Other recent studies have found that diabetes disease management programs significantly lowered costs and increased quality of care. As disease management continues to focus on the patient's role in the care process, the importance of providing easy-to-use tools to facilitate the tracking of conditions like diabetes continues to increase.

This brings us to the invention. MyCareConnect was born out of the basic need of a parent of a Type-1 Diabetic to communicate more effectively with her child's caregivers. MyCareConnect embraces both of the disciplines listed above.

MyCareConnect is a secure, HIPAA-compliant web-based patient-management system that not only provides real-time access to patient data, but also aids in the speed and accuracy with which patients are treated. A secure messaging feature provides a method for private communication between patients and their clinicians by facilitating transactions using a secure database, requiring user authentication and authorization. This feature eliminates the need to rely on fax and phone calls. It greatly reduces a clinicians time corresponding with patients and vice-versa.

MyCareConnect not only offers enormous gains in data efficiency and accuracy but also simplifies the overall patient care experience. It empowers individuals to take ownership of their condition, an important step in disease and condition management.

Through MyCareConnect, children and their families can:
Share data, previously hand-recorded, in a real-time environment
Decide who they want to share data with (clinicians, school nurses, parents, etc . . . )
Receive guidance and treatment from caregivers, real-time.
Decide how they want to receive communications; through e-mail, text messaging, phone, pager, PDA or the internet.
Access historical data for reference

Through MyCareConnect, clinicians can:
Review patient data real-time
Determine how each patients data is presented (i.e. certain data is color coded based on clinician parameters)
Determine warning levels for each patient
Receive instant notifications when warning levels for a patient are received
Managing the prioritization of more than one patient at a time
Communicate with colleagues and patients using secure messaging
Provide remote treatment to patients
Eliminate paper-based processes
Prepare patient records for historical storage including bar-coding and digital scanning

### BRIEF SUMMARY OF THE INVENTION

The system for collecting, managing, transmitting, analyzing and communicating medical and health-related data may or may not comprise a measuring device (not controlled or produced by MCC) that measures physiological attributes, a data entry method provided by MCC to the end-user for capturing pertinent data for use by caregivers in the assessment and diagnosis of patients, an analytical engine that interprets and presents the patient-submitted data for use by caregivers and patients alike, and a communications system used to transmit caregiver and patient feedback between parties. The system includes two (2) primary methods for viewing the health-related information: a patient subsystem and a caregiver subsystem.

The Patient Setup below describes the unique process by which authorized end-users create their account, build their network of caregivers to be included in their personal network, and create patient guidelines for managing, communicating and analyzing patient progress on a real-time basis.

The Patient Subsystem below describes the unique process by which authorized end-users not representing the healthcare provider will utilize the system for capturing data, viewing quick data analysis, and initiating communications amongst their network of caregivers per the patient setup.

The Caregiver Setup below describes the unique process by which authorized healthcare providers will confirm and set up patient accounts which fall within their care. This will include pertinent patient data, guidelines for monitoring and communications, as well as alerts and scheduling related to the ongoing patient care.

The Caregiver Subsystem below describes the unique process by which authorized healthcare providers will access patient information in a variety of manners, some named here: prioritized based on need, scheduled reviews, alerts related to prior communications, alerts initiated by the patient directly, and others. The caregiver subsystem will then enable analysis of patient information and a method of communicating with the patient via online and mobile solutions.

### BRIEF DESCRIPTION OF THE SEVERAL VIEWS OF THE DRAWING

FIG. 1: Database and system structure.

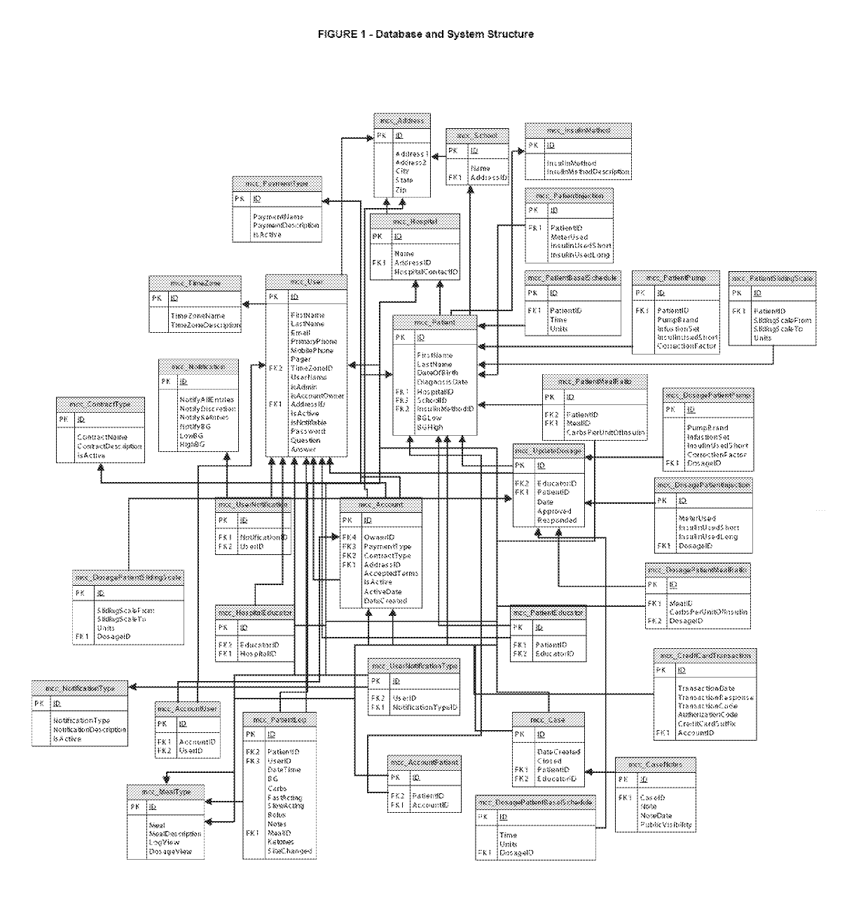

### DETAILED DESCRIPTION OF THE INVENTION

Patient Setup

Patient's personal and medical data is entered and stored on the system to serve as caregiver guidelines based on prior diagnosis and treatment. Additionally, networks of caregivers will be identified and provided with varying levels of account administration.

The method of communication and notification within the caregiver network are also determined within Patient setup (to include but not limited to e-mail addresses, phone numbers, pagers, and text messaging). Methods of communication are identified and prioritized for each caregiver setup in the Patient setup toolset.

Additionally, the system is designed to collect and store specific patient profile data used by the system in both the Caregiver and Patient subsystems. Patient data may include, but is not limited to blood glucose thresholds, type of insulin used, dosage data, and other pertinent medical information important to continued care and diagnosis.

Patient Subsystem

The patient subsystem is designed for use by patients and has unique data entry and presentation functionality. As a patient enters daily measurements and communication data into the system, the data is time stamped and formatted to be stored in the patient subsystem database. At this moment, a communiqué is launched and includes a text string containing the aforementioned patient data which is inserted into the body of a message sent to the pre-determined communication addresses found in the Patient Setup tools.

For example, a 9 year old diabetic patient has just conducted a blood glucose test at her school using a blood glucose meter and taken a certain dosage of insulin. The patient then enters the test results and resulting insulin dosage into the system. After the data, the blood glucose reading and insulin dosage is entered into the system (from a nurses office or teachers classroom), the system checks the patient setup file for pre-determined notifications as data is entered into the system. Both her parents have setup e-mails and text messaging for notifications, and they are immediately notified through these methods of her status. The result is the opportunity for them to either take comfort in her status, or become engaged and contact her classroom to check on her progress, either through the communication tools found in the patient subsystem, or through their own methods.

Caregiver Setup

Healthcare providers will sign up to be part of the caregiver network of healthcare providers, i.e. Children's Medical Center of Dallas. Once a healthcare provider is signed up, they can actively monitor patients and provide diagnosis.

Part of the Caregiver Setup is confirming and ensuring that patient data is accurate and being measured at appropriate levels. The caregiver setup allows a patients healthcare provider to set alerts, alarms, schedules, and acceptable ranges of data based on an individual patient's medical history and current progress.

Caregiver Subsystem

All of the collected patient data is useful in determining a patient's compliance with prescribed medical regimen. As such, the data is formatted and presented in a manner for persons skilled in the art of diabetic patient management to effectively analyze patient data. The logic used to aid in analysis of patient data includes the color-coding of data based on criteria stored in the Patient Subsystem and monitored by the caregiver.

For our patient example, let us assume that acceptable blood glucose levels have been set between 70 and 150. The MCC system would color-code any blood glucose reading above 150 with a RED color and those below 70 would be color-coded YELLOW.

The color-coding system is a direct result of Children's Medical Center of Dallas' current method of looking for patient blood glucose trends through the use of highlighting highs and lows that fall outside of an acceptable patient blood glucose range.

For our healthcare provider example, let us assume a diabetic nurse (caregiver) may be treating a patient on the system by viewing the blood glucose data over a period of time and quickly analyzing the data with the help of the color coding logic. This allows the nurse to diagnose and apply treatment more effectively. Today, many hospitals require patients to keep manual, paper-based logs of their blood glucose readings which are then faxed into the hospital for the staff to review.

In addition, the Caregiver Subsystem appends logic to aid a caregiver in managing the prioritization of more than one patient case at a time. This logic is based on preset patient criteria, including but not exclusive to: blood glucose levels, patient initiated alarms in the system, length of time since diagnosis, and length of time in the patient case queue. For example, most diabetic hospital staffs are juggling multiple cases/patients at one time and have to determine which cases take precedence. Adding prioritization logic to the system aids in the management of patient queues and thus quicker, more effective treatment of patients most in need of care.

The caregiver's communication system provides an interface for transmitting medical diagnosis and treatment data to and from caregiver and patient, as well as a method of receipt confirmation required of the patient confirming receipt of the message from the caregiver. If no receipt confirmation takes place, the caregiver is notified via any number of communication methods (email, pager, text message) and they can initiate contact with the patient in a timely manner.

For example, after analyzing a patient's data, the nurse uses the communication system to communicate a diagnosis and recommended action to the patient. If the patient reviews the information and agrees to move forward with the recommended treatment, the patient can issue a confirmation and acceptance. However, the patient may disagree and issue a response without closing the patient case. The last option may be that the patient does not respond in any manner. In this case, the caregiver will be notified and can initiate another communiqué via the MCC system, or simply contact the patient via telephone and capture any comments into the MCC system for documentation.

Today, hospital nursing staffs spend significant time on the phone with patients as well as monitoring the fax machine which limits their effectiveness in managing patient queues used to diagnose and treat their patients.

What is claimed is:

1. A system and method for enabling an individual, business, or other entity to exchange, real-time, confidential health related information over a public network.

2. A system and method of sending automated communications, including e-mail, text messaging, phone, pager, PDA or the internet, as soon as data is keyed and processed on the patient subsystem.

3. A system and method for granting access on the patient subsystem to what is claimed in [1] by authorized individuals, businesses or other public entities.

4. A system and method for the arrangement of pre-set data on the caregiver subsystem used to determine the presentation of data that can be color coded or some other currently known graphical method (such as blinking).

5. A system and method for the arrangement of pre-set data on the caregiver subsystem used to trigger a communication as described in claim [1].
